(19) United States
(12) Patent Application Publication
(10) Pub. No.: US 2015/0056009 A1
(43) Pub. Date: Feb. 26, 2015

(54) ELASTIC AVERAGING SNAP MEMBER ALIGNING AND FASTENING SYSTEM

(71) Applicant: GM GLOBAL TECHNOLOGY OPERATIONS LLC, Detroit, MI (US)

(72) Inventors: Steven E. Morris, Fair Haven, MI (US); Jennifer P. Lawall, Waterford, MI (US)

(73) Assignee: GM GLOBAL TECHNOLOGY OPERATIONS LLC, Detroit, MI (US)

(21) Appl. No.: 13/974,729

(22) Filed: Aug. 23, 2013

(51) Int. Cl. F16B 21/08

(52) U.S. Cl. CPC F16B 21/08
USPC 403/326; 29/453

(57) ABSTRACT

An elastically averaging snap member aligning and fastening system has a first component and a second component. The first component includes a first body having a first surface portion and a second surface portion, the first body including one or more apertures extending between the first and second surface portions. The second component includes a second body having a first surface section and a second surface section, the second body including one or more elastically averaging snap members provided on one of the first and second surface sections. Each of the one or more elastically averaging snap members include a plurality of cantilevered snap elements configured and disposed to interferingly, deformably, elastically and matingly engage with corresponding ones of the one or more apertures.

### FIELD OF THE INVENTION

The subject invention relates to the art of aligning and fastening systems, and more particularly to an elastic averaging snap member aligning and fastening system.

### BACKGROUND

Currently, components, particularly vehicular components such as those found in automotive vehicles, which are to be mated together in a manufacturing process are mutually located with respect to each other by alignment features that are oversized and/or undersized to provide spacing to freely move the components relative to one another to align them without creating an interference therebetween that would hinder the manufacturing process. One example includes two-way and/or four-way male alignment features, typically upstanding bosses, which are received into corresponding female alignment features, typically apertures in the form of holes or slots. There is a clearance between the male alignment features and their respective female alignment features which is predetermined to match anticipated size and positional variation tolerances of the male and female alignment features as a result of manufacturing (or fabrication) variances. As a result, significant positional variation can occur between the mated first and second components having the aforementioned alignment features, which may contribute to the presence of undesirably large variation in their alignment, particularly with regard to the gaps and spacing between them. In the case where these misaligned components are also part of another assembly, such misalignments can also affect the function and/or aesthetic appearance of the entire assembly. Regardless of whether such misalignment is limited to two components or an entire assembly, it can negatively affect function and result in a perception of poor quality.

To align and secure components, the aforementioned male and female alignment features may be employed in combination with separate securing features, such as nuts and bolts, snap/push-in fasteners, plastic rivets, and snap rivets, to name a few, that serve to secure the components to each other. In such an assembly, the mating components are located relative to each other by the alignment features, and are fixed relative to each other by the securing features. Use of separate alignment features and securing features, one for alignment and the other for securement, may limit the effectiveness of each on a given assembly, as the alignment features cannot be employed where the securing features are employed.

Accordingly, the art of aligning and fastening systems can be enhanced by providing an aligning and fastening system or mechanism that can ensure precise four-way alignment and securement of two components via elastic averaging of a snap-acting elastically deformable aligning and fastening element disposed in mating engagement with a corresponding alignment aperture.

### SUMMARY OF THE INVENTION

An embodiment of the invention includes an elastically averaging snap member aligning and fastening system having a first component and a second component. The first component includes a first body having a first surface portion and a second surface portion, the first body including one or more apertures extending between the first and second surface portions. The second component includes a second body having a first surface section and a second surface section, the second body including one or more elastically averaging snap members provided on one of the first and second surface sections. Each of the one or more elastically averaging snap members include a plurality of cantilevered snap elements configured and disposed to interferingly, deformably, elastically and matingly engage with corresponding ones of the one or more apertures.

Another embodiment of the invention includes a method of joining a first component to a second component through an elastically averaging snap member aligning and fastening system. The method includes: aligning a first aperture provided on a first component with a first elastically averaging snap member provided on a second component; interferingly, deformably, elastically and matingly engaging the first elastically averaging snap member with the first aperture; aligning a second aperture provided on the first component with a second elastically averaging snap member provided on the second component; and, interferingly, deformably, elastically and matingly engaging the second elastically averaging snap member with the second aperture to establish an elastically averaged position of the first component relative to the second component.

The above features and advantages and other features and advantages of the invention are readily apparent from the following detailed description of the invention when taken in connection with the accompanying drawings.

### BRIEF DESCRIPTION OF THE DRAWINGS

Other features, advantages and details appear, by way of example only, in the following detailed description of embodiments, the detailed description referring to the drawings in which:

FIG. 1 depicts a disassembled assembly view of an elastically averaging snap member aligning and fastening system having a first component and a second component, and an elastically deformable snap member, in accordance with an embodiment of the invention;

FIG. 2 depicts a front plan view of the assembly of FIG. 1 with the first component fully assembled to the second component, in accordance with an embodiment of the invention;

FIG. 3 depicts a cross section view of the elastically averaging snap member aligning and fastening system of FIG. 2 taken through cut lines 3-3, with the first and second components disposed in a full-engagement position relative to each other, in accordance with an embodiment of the invention;

FIG. 4 depicts a cross section view similar to that of FIG. 3, but with the first and second components disposed in a pre-engagement position relative to each other, in accordance with an embodiment of the invention;

FIG. 5 depicts a cross section view similar to that of FIG. 4, but with the first and second components disposed in a partial-engagement position relative to each other, in accordance with an embodiment of the invention;

FIG. 6 depicts a cross section view similar to that of FIG. 3, but of an elastically averaging snap member aligning and fastening system in accordance with another embodiment of the invention; and

FIG. 7 depicts an isometric perspective view of an elastically deformable snap member alternative to that depicted in FIG. 1, in accordance with an embodiment of the invention.

### DESCRIPTION OF THE EMBODIMENTS

The following description is merely exemplary in nature and is not intended to limit the present disclosure, its application or uses. For example, the embodiments shown may comprise vehicle panels but the alignment system may be used with any suitable components to provide elastic averaging for precision location and alignment of all manner of mating components and component applications, including many industrial, consumer product (e.g., consumer electronics, various appliances and the like), transportation, energy and aerospace applications, and particularly including many other types of vehicular components and applications, such as various interior, exterior and under hood vehicular components and applications. It should be understood that throughout the drawings, corresponding reference numerals indicate like or corresponding parts and features.

As used herein, the term “elastically deformable” refers to components, or portions of components, including component features, comprising materials having a generally elastic deformation characteristic, wherein the material is configured to undergo a resiliently reversible change in its shape, size, or both, in response to application of a force. The force causing the resiliently reversible or elastic deformation of the material may include a tensile, compressive, shear, bending or torsional force, or various combinations of these forces. The elastically deformable materials may exhibit linear elastic deformation, for example that described according to Hooke's law, or non-linear elastic deformation.

Elastic averaging provides elastic deformation of the interface(s) between mated components, wherein the average deformation provides a precise alignment, the manufacturing positional variance being minimized to Xₘᵢₙ, defined by Xₘᵢₙ=X/√N, wherein X is the manufacturing positional variance of the locating features of the mated components and N is the number of features inserted. To obtain elastic averaging, an elastically deformable component is configured to have at least one feature and its contact surface(s) that is over-constrained and provides an interference fit with a mating feature of another component and its contact surface(s). The over-constrained condition and interference fit resiliently reversibly (elastically) deforms at least one of the at least one feature or the mating feature, or both features. The resiliently reversible nature of these features of the components allows repeatable insertion and withdrawal of the components that facilitates their assembly and disassembly. Positional variance of the components may result in varying forces being applied over regions of the contact surfaces that are over-constrained and engaged during insertion of the component in an interference condition. It is to be appreciated that a single inserted component may be elastically averaged with respect to a length of the perimeter of the component. The principles of elastic averaging are described in detail in commonly owned, co-pending U.S. patent application Ser. No. 13/187,675, the disclosure of which is incorporated by reference herein in its entirety. The embodiments disclosed above provide the ability to convert an existing component that is not compatible with the above-described elastic averaging principles, or that would be further aided with the inclusion of a four-way elastic averaging alignment and fastening system as herein disclosed, to an assembly that does facilitate elastic averaging and the benefits associated therewith.

Any suitable elastically deformable material may be used for the mating components and alignment features disclosed herein and discussed further below, particularly those materials that are elastically deformable when formed into the features described herein. This includes various metals, polymers, ceramics, inorganic materials or glasses, or composites of any of the aforementioned materials, or any other combinations thereof suitable for a purpose disclosed herein. Many composite materials are envisioned, including various filled polymers, including glass, ceramic, metal and inorganic material filled polymers, particularly glass, metal, ceramic, inorganic or carbon fiber filled polymers. Any suitable filler morphology may be employed, including all shapes and sizes of particulates or fibers. More particularly any suitable type of fiber may be used, including continuous and discontinuous fibers, woven and unwoven cloths, felts or tows, or a combination thereof. Any suitable metal may be used, including various grades and alloys of steel, cast iron, aluminum, magnesium or titanium, or composites thereof, or any other combinations thereof. Polymers may include both thermoplastic polymers or thermoset polymers, or composites thereof, or any other combinations thereof, including a wide variety of co-polymers and polymer blends. In one embodiment, a preferred plastic material is one having elastic properties so as to deform elastically without fracture, as for example, a material comprising an acrylonitrile butadiene styrene (ABS) polymer, and more particularly a polycarbonate ABS polymer blend (PC/ABS). The material may be in any form and formed or manufactured by any suitable process, including stamped or formed metal, composite or other sheets, forgings, extruded parts, pressed parts, castings, or molded parts and the like, to include the deformable features described herein. The elastically deformable alignment features and associated component may be formed in any suitable manner. For example, the elastically deformable alignment features and the associated component may be integrally formed, or they may be formed entirely separately and subsequently attached together. When integrally formed, they may be formed as a single part from a plastic injection molding machine, for example. When formed separately, they may be formed from different materials to provide a predetermined elastic response characteristic, for example. The material, or materials, may be selected to provide a predetermined elastic response characteristic of any or all of the elastically deformable alignment features, the associated component, or the mating component. The predetermined elastic response characteristic may include, for example, a predetermined elastic modulus.

As used herein, the term vehicle is not limited to just an automobile, truck, van or sport utility vehicle, but includes any self-propelled or towed conveyance suitable for transporting a burden.

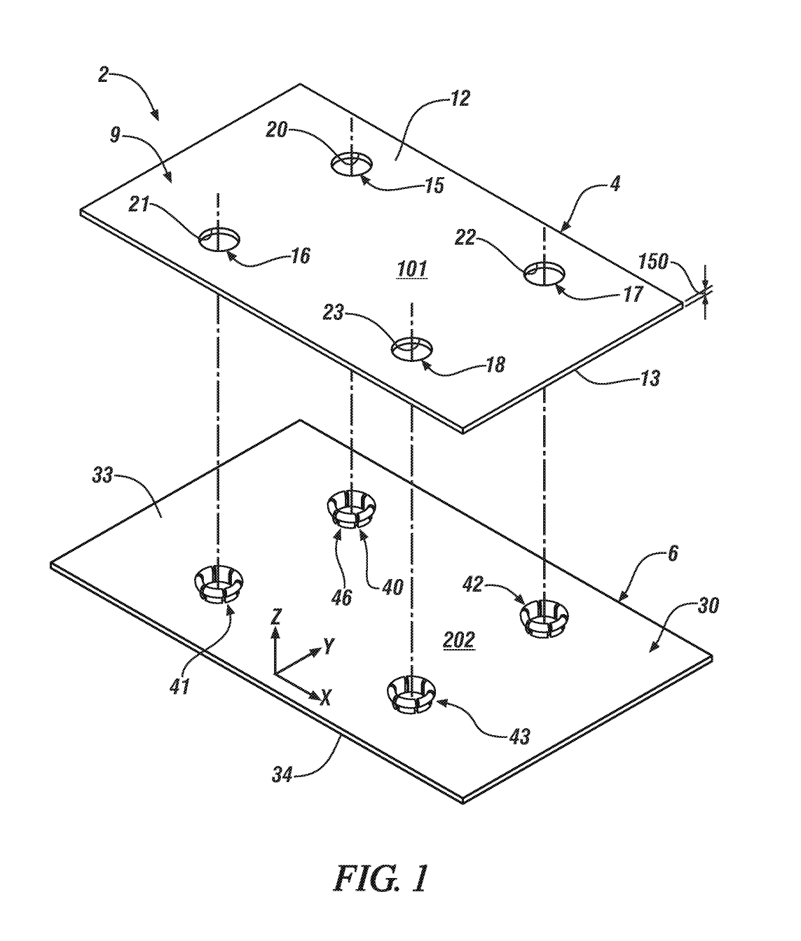

With reference to FIG. 1, an elastically averaging snap member aligning and fastening system in accordance with an embodiment is indicated generally at 2 (herein also referred to as the EA system 2). The EA system 2 includes a first component 4 and a second component 6. The first component 4 includes a first body 9 having a first surface portion 12 and an opposing second surface portion 13 with a thickness “150” therebetween. While illustrated as being substantially planar, the first and second surface portions 12 and 13 may also include various non-planar elements. The first component 4 is also shown to include a first aperture 15, a second aperture 16, a third aperture 17 and a fourth aperture 18. Apertures 15-18 have the form of respective passages 20-23 that extend through the first body 9 from the first surface portion 12 to the second surface portion 13.

In an embodiment, the second component 6 includes a second body 30 including a first surface section 33 and an opposing second surface section 34. In a manner similar to that described above, while illustrated as being substantially planar, first and second surface sections 33 and 34 may also include various non-planar elements. The second component 6 also includes a first elastically averaging aligning and fastening snap member 40, a second elastically averaging aligning and fastening snap member 41, a third elastically averaging aligning and fastening snap member 42, and a fourth elastically averaging aligning and fastening snap member 43. Elastically averaging aligning and fastening snap members (also herein referred to as EA snap members) 40-43 are arranged to inter-engage with respective apertures 15-18.

While FIG. 1 depicts four apertures 15-18 and four EA snap members 40-43, it will be appreciated that the scope of the invention is not so limited, and also encompasses any number of EA snap members disposed to engage with a respective number of apertures.

For discussion purposes, the non-mating side of the first component 4 visible in FIG. 1 is labeled 101, and the mating side of the second component 6 visible in FIG. 1 is labeled 202. The non-visible sides of the first and second components 4, 6 are hidden from view in FIG. 1. For discussion purposes, a plan view of the EA system 2 as viewed from side 101 of the first component 4 is herein referred to as a front plan view, and a plan view of the EA system 4 as viewed from hidden side of the second component 6 is herein referred to as a rear plan view.

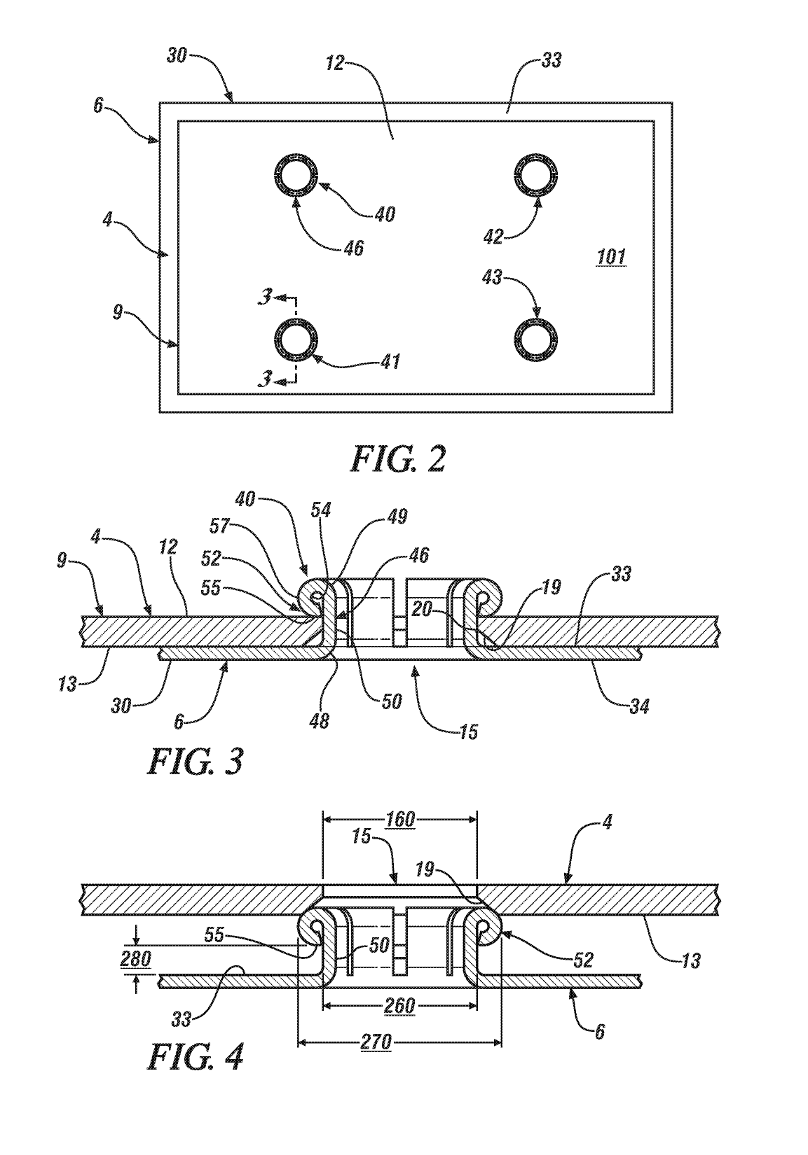

FIG. 2 depicts a front plan view of the assembly of FIG. 1 with the first component 4 fully assembled with the second component 6, and with EA snap members 40-43 fully engaged with apertures 15-18 in a manner that will now be described with reference to FIGS. 3-5.

With reference now to FIG. 3, each EA snap member 40-43 (EA snap member 40 depicted in FIG. 3) includes a plurality of cantilevered snap elements such as indicated at 46 illustrated on EA snap member 40 in FIG. 1. As depicted, each cantilevered snap element 46 extends from a first end portion 48 to a second, cantilevered, end portion 49 through an intermediate portion 50. The first end portion 48 extends directly from the second component 6 such that each EA snap member 40-43 is materially integrally formed with the second body 30. Each cantilevered snap element 46 also includes a flange section 52 provided at the second end portion 49. The flange section 52 extends from a first end section 54 to a second end section 55 through an intermediate/curvilinear section 57. In the embodiment shown, the second end section 55 of the flange section 52 extends toward the intermediate portion 50 of cantilevered snap element 46. In this manner, the second end section 55 interferingly, deformably and matingly engages with the first surface portion 12 to secure each EA snap member 40-43 to the first component 4, and more particularly to align and fasten in and elastically averaged arrangement the first component 4 to the second component 6.

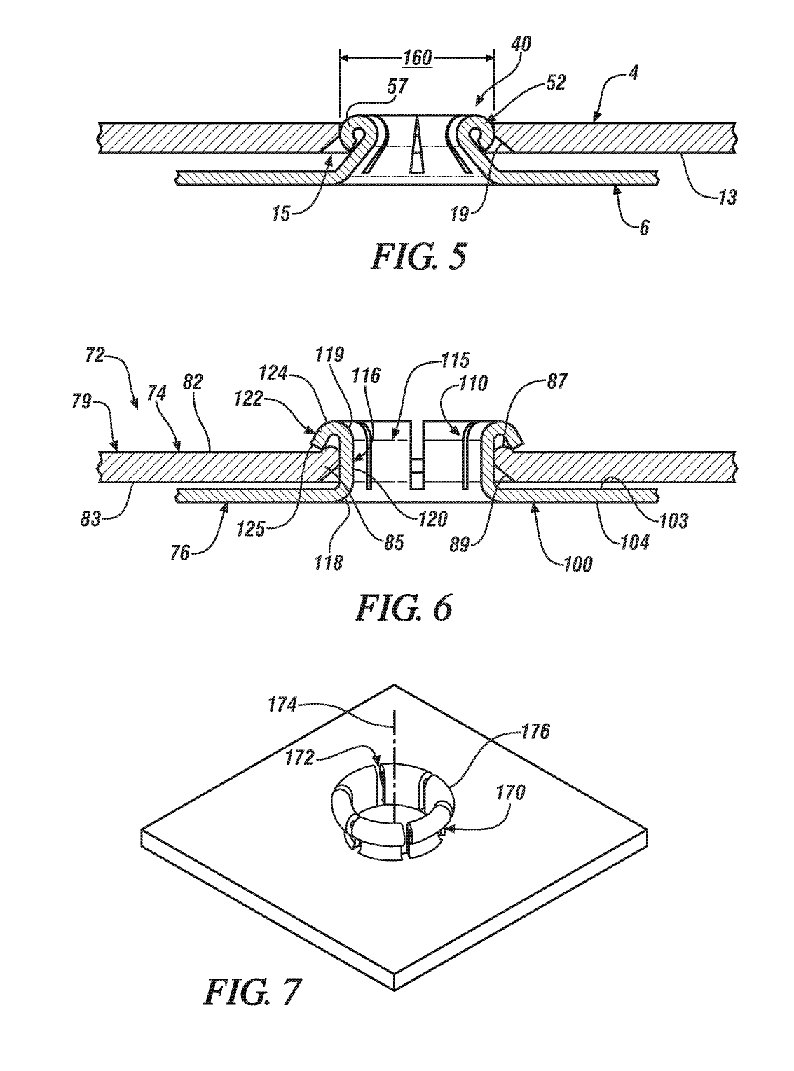

Reference is now made to FIGS. 4 and 5 in combination with FIG. 3, where FIG. 4 depicts a cross section view similar to that of FIG. 3, but with the first and second components 4, 6 disposed in a pre-engagement position relative to each other, and FIG. 5 depicts a similar cross section view, but with the first and second components 4, 6 disposed in a partial engagement position relative to each other. As will be appreciated when comparing FIGS. 3-5 with respect to each other, FIGS. 3-5 generally depict three stages of assembly of the first component 4 to the second component 6 (full-engagement depicted in FIG. 3, pre-engagement depicted in FIG. 4, and partial-engagement depicted in FIG. 5), with the elastically deformable characteristics of the EA snap members 40-43 being illustrated.

In the pre-engagement stage of assembly, and with reference to FIG. 4, an embodiment includes an arrangement where not only is the outer diameter 270 of the flange section 52 greater than the inner diameter 160 of the aperture 15, but also the outer diameter 260 of the intermediate portion 50 is greater than the inner diameter 160 of the aperture 15, for a purpose explained further below.

As the first and second components 4, 6 come into engagement with each other, and with reference now to FIG. 5, the flange sections 52, aided by the shape of the curvilinear section 57 of each flange section 52 acting against a chamfer 19 formed in the second surface portion 13 of the first component 4, will elastically deform inward so the EA snap member 40 can clear and pass through the aperture 15.

At the full-engagement stage of assembly, and with reference now back to FIG. 3, the flange sections 52 snap outward as they pass through the aperture 15.

In such an arrangement where dimension “270”>“260”>“160”, the flange sections 52 of the cantilevered snap elements 46 of each EA snap member 40 will elastically deform inward in order for the EA snap member 40 to clear and pass through the aperture 15, and then they will snap back outward when the EA snap member 40 has passed through the aperture 15, but not completely back to their original pre-engagement position, as the flange sections 52 will remain slightly biased against the inner diameter 160 of the aperture 15, which will result in an elastically averaging snap member aligning and fastening system 10 when multiple EA snap members 40 and corresponding apertures 15 are employed, as depicted in FIG. 1.

From the foregoing, it will be appreciated that the first component 4 and the second component 6 are configured to engage with each other when a top rolled portion (flange section 52) of each EA snap member 40-43 flexes in and then snap fits over an edge of a respective aperture 15-18 in the first component 4.

Additionally, an embodiment includes an arrangement where the opening 280 between the first surface section 33 of the second component 6, and the second end section 55 of the flange section 52, is less than the thickness 150 of the first component 4 (see FIGS. 1 and 4, for example), thereby resulting in a clamping action between the first and second components 4, 6 when elastically aligned and fastened together.

Reference is now be made to FIG. 6, which depicts an EA system 72 in accordance with another embodiment of the invention. EA system 72 includes a first component 74 and a second component 76. As will be discussed more fully below, the first component 74 and the second component 76 are configured and disposed to interferingly, deformably, elastically and matingly engage with each other in a snap-fit aligning and fastening arrangement, similar to that described above in connection with FIGS. 1-5. The first component 74 includes a first body 79 having a first surface portion 82 and an opposing second surface portion 83. While shown as being substantially planar, the first and second surface portions 82 and 83 may also include various non-planar elements. The first component 74 is also shown to include an aperture 115, similar to the aperture 15 depicted in FIG. 1, and a retaining element 85 disposed around the perimeter of the aperture 115.

As depicted in FIG. 6, the aperture 115 extends through the first body 79 from the first surface portion 82 to the second surface portion 83. The retaining element 85 includes an upper retaining portion 87 provided on the first surface portion 82, and a lead-in portion 89 provided on the second surface portion 83. The retaining portion 87 takes the form of a raised ridge (also herein referred to by reference numeral 87) extending about receiving perimeter of the retaining element 85 on the first surface portion 82. The lead-in portion 89 takes the form of a sloping or ramped ridge, alternatively herein referred to as a chamfer, (also herein referred to by reference numeral 89) provided about the retaining element 85 on the second surface portion 83.

In the embodiment of FIG. 6, the second component 76 includes a second body 100 including a first surface section 103 and an opposing second surface section 104. In a manner similar to that described above, while shown as being substantially planar, first and second surface sections 103 and 104 may also include various non-planar elements. The second component 76 also includes an EA snap member 110 that is arranged to inter-engage with the retaining portion 87 of the retaining element 85 disposed about aperture 115. In view of all of the foregoing, it will be understood that the number of retaining elements 85 and EA snap members 110 may be greater than one each, with each set being arranged to interferingly, deformably, elastically and matingly engage with each other in an elastic averaging snap member aligning and fastening system.

In an embodiment, and with reference still to FIG. 6, EA snap member 110 includes a plurality of cantilevered snap elements, one of which is indicated at 116. Each cantilevered snap element 116 extends from a first end portion 118 to a second, cantilevered, end portion 119 through an intermediate portion 120. The first end portion 118 extends directly from the second component 76 such that the EA snap member 110 is materially integrally formed with second body 100. Each cantilevered snap element 116 also includes a flange section 122 provided at the second end portion 119. Flange section 122 extends from a first end section 124 to a second end section 125. In the embodiment depicted in FIG. 6, the second end section 125 of the flange section 122 extends toward the first surface section 82 to form a second end retaining section (also herein referred to by reference numeral 125). In this manner, the second end retaining section 125 engages with the retaining portion 87 of the retaining element 85 to secure the EA snap member 110 with the retaining element 85, thereby securing the first and second components 74, 76 to each other. In a manner similar to that discussed above, cantilevered snap elements 116 facilitate an elastically averaged relative position of the first component 74 with the second component 76 to allow for precision alignment of the first component 74 to the second component 76.

Reference is now made to FIG. 7, which depicts an EA snap member 170 similar to that of EA snap member 40 depicted in FIGS. 1 and 3, but with elongated slots 172 oriented parallel with the central axis 174 of the EA snap member 170. EA snap member 170 functions in a similar manner as EA snap member 40 discussed above, but with an added degree of elastically deformable flexibility in the cantilevered snap elements 176 (similar to the cantilevered snap elements 46 depicted in FIG. 3). In an embodiment, the elongated slots 172 may extend the entire length of the EA snap member 170 for added flexibility in the cantilevered snap elements 176.

In an embodiment, EA system 2 may employ one or more of EA snap members 40, 110 and/or 170.

In commonly owned co-pending U.S. Patent Application having Attorney Docket No.: P022550-GMVE-DPH, the disclosure of which is incorporated herein by reference in its entirety, an elastically deformable aperture is illustrated and described that could be employed in place of one or more apertures 15-18. By employing such an elastically deformable aperture with an elastically deformable EA snap member 40, 110 and/or 170, a more elastically compliant EA system 2 will result.

In view of all that is disclosed and illustrated herein, in combination with other elastic averaging alignment elements and/or apertures as disclosed in commonly owned, co-pending U.S. patent application Ser. No. 13/187,675, and in commonly owned co-pending U.S. Patent Application having Attorney Docket No.: P022550-GMVE-DPH, for example, it will be appreciated that the scope of the invention is not limited to the use of the herein disclosed elastically deformable aligning and fastening snap member 40 by itself, but also encompasses the use of an elastically deformable aligning and fastening snap member 40 in combination with other elastic averaging alignment features, male or female. By using one or more elastically deformable aligning and fastening snap member 40, with or without other elastic averaging alignment apertures, added precision in the alignment of the first and second components 100, 200 can result.

At this point it should be understood that the example embodiments presented herein describe an elastically averaging snap member aligning and fastening system that not only facilitates a snap-fit connection between mating parts, but also accommodates positional irregularities between the mating parts. More specifically, the EA snap members include elastic averaging members that take the form of cantilevered snap elements that allow for additional movement to accommodate any misalignments between two or more mating parts allowing for superior alignment and quality. It should also be understood, that the first and second components described herein may be formed from a variety of plastics, metal (including sheet metal) as well as various composite materials. Further, it should be understood that the EA system may be employed to join dissimilar materials. For example, the EA system may be employed to join a plastic member with a member formed from a metal.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the application.

What is claimed is:

1. An elastically averaging snap member aligning and fastening system comprising:
a first component including a first body having a first surface portion and a second surface portion, the first body including one or more apertures extending between the first and second surface portions;
a second component including a second body having a first surface section and a second surface section, the second body including one or more elastically averaging snap members provided on one of the first and second surface sections, each of the one or more elastically averaging snap members including a plurality of cantilevered snap elements configured and disposed to interferingly, deformably, elastically and matingly engage with corresponding ones of the one or more apertures.

2. The system according to claim 1, wherein each of the plurality of cantilevered snap elements extends from a first end portion to a second, cantilevered, end portion through an intermediate portion, the cantilevered end portion having a flange section.

3. The system according to claim 2, wherein the flange section extends from a first end section to a second end section.

4. The system according to claim 3, wherein the second end section extends toward the intermediate portion.

5. The system according to claim 2, further comprising: a retaining element provided about the one or more apertures on the first surface portion.

6. The system according to claim 5, further comprising: a lead-in section arranged about the one or more apertures on the second surface portion.

7. The system according to claim 2, further comprising: a lead-in section arranged about the one or more apertures on second surface portion.

8. The system according to claim 1, wherein each of the one or more elastically averaging snap members is materially integrally formed with the second component.

9. The system according to claim 1, wherein at least one of the first and second components is formed from a plastic.

10. The system according to claim 1, wherein at least one of the first and second components is formed from a metal.

11. The system according to claim 1, wherein one of the first and second components is formed from a plastic and the other of the first and second components is formed from a metal.

12. The system according to claim 1, wherein:
at least one of the plurality of cantilevered snap elements of each of the one or more elastically averaging snap members is elastically biased against an inner diameter of a respective one of the one or more apertures.

13. A method of joining a first component to a second component through an elastically averaging snap member aligning and fastening system, the method comprising:
aligning a first aperture provided on a first component with a first elastically averaging snap member provided on a second component;
interferingly, deformably, elastically and matingly engaging the first elastically averaging snap member with the first aperture;
aligning a second aperture provided on the first component with a second elastically averaging snap member provided on the second component; and
interferingly, deformably, elastically and matingly engaging the second elastically averaging snap member with the second aperture to establish an elastically averaged position of the first component relative to the second component.

14. The method of claim 13, wherein aligning the first aperture provided on the first component with the first elastically averaging snap member provided on the second component includes guiding a first plurality of cantilevered snap elements forming the elastically averaging snap member through a passage defining the aperture.

15. The method of claim 14, wherein guiding the first plurality of cantilevered snap elements of the first elastically averaging snap member through the passage defining the aperture includes passing one or more of the first plurality of cantilevered snap elements over a lead-in section extending around the passage.

16. The method of claim 13, wherein interferingly, deformably, elastically and matingly engaging the first elastically averaging snap member with the first aperture includes abutting a flange section provided on the first elastically averaging snap member with the first component.

17. The method of claim 16, wherein abutting the flange section provided on the first elastically averaging snap member with the first component includes engaging the flange section with a retaining element provided about the first aperture.

18. The method of claim 14, wherein:
the interferingly, deformably, elastically and matingly engaging the second elastically averaging snap member with the second aperture comprises biasing at least one of the plurality of cantilevered snap elements of each of the first and second elastically averaging snap members against an inner diameter of a respective one of the first and second apertures to establish an elastically averaged position of the first component relative to the second component.
